(19) United States
(12) Patent Application Publication
(10) Pub. No.: US 2015/0225672 A1
(43) Pub. Date: Aug. 13, 2015

(54) CLEANSER AND USE OF THE CLEANSER FOR CLEANING A HARD ARTICLE

(71) Applicant: 3M INNOVATIVE PROPERTIES COMPANY, Saint Paul, MN (US)

(72) Inventors: Xue-hua Chen, Shanghai (CN); Lei Zhang, Shanghai (CN)

(73) Assignee: 3M INNOVATIVE PROPERTIES COMPANY, Saint Paul, MN (US)

(21) Appl. No.: 14/435,024

(22) PCT Filed: Sep. 23, 2013
(86) PCT No.: PCT/US2013/061122

§ 371 Date: Apr. 10, 2015

(30) Foreign Application Priority Data
Oct. 11, 2012 (CN) 201210384352.2

(51) Int. Cl. C11D 3/12; C11D 1/722

(52) U.S. Cl. CPC C11D 3/1266; C11D 1/722

(57) ABSTRACT

The invention provides a cleanser comprising an aqueous solvent and 0.05 to 10% by weight of layered silicate dispersed in the aqueous solvent, wherein the layered silicate has an average specific surface area of 100 m²/g or more. The cleanser has durable easy-cleaning function and allows the decrease of cleaning frequency of a hard article so that labor and expense required for cleaning a hard article can be reduced.

### CROSS REFERENCE TO RELATED APPLICATION

This application claims the benefit of Chinese Patent Application No. 201210384352.2, filed Oct. 11, 2012, the disclosure of which is incorporated by reference herein in its entirety.

### TECHNICAL FIELD

The invention relates to a cleanser and use of the cleanser for cleaning a hard article.

### BACKGROUND ART

Many cleansers for cleaning a hard article are available in the market. However, most of the toilet cleansers in the market have an acidic formulation and the kitchen cleansers have an alkaline formulation. Generally, these cleansers have an irritating odor and are corrosive. Further, common household cleansers only provide an instantaneous cleaning effect and do not have durable easy-cleaning function, so that labor required for cleaning is increased. In addition, many cleansers have a strong alkaline or acidic property and will result in the damage of a hard article if used for a long time. With the development of society and the progress of technology, the consumer's requirements for cleaning and maintaining a hard article are increasing.

WO2009040597A1 has described a hard surface cleanser comprising 0.1 to 60% by weight of solid inorganic particles having a crystallinity degree of 25 to 35%, a particle size of 0.5 to 1.5 μm, and a specific surface area of 10 to 50 m₂/g. When the cleanser is used for cleaning a surface, the damage of the surface to be cleaned due to abrasion can be reduced while increasing the hydrophilicity of the surface to be cleaned. However, the hard surface cleanser disclosed in WO2009040597A1 does not relate to the durable easy-cleaning and protective functions.

A cleanser having durable easy-cleaning function is attractive for consumers, because the durable easy-cleaning function enables the decrease of cleaning frequency of a hard article so that labor required for cleaning a hard article can be decreased, the expense required to clean a hard article can be saved, and the pollution of the environment can be reduced. Considering these requirements of the consumers, there is needed a cleanser having durable easy-cleaning function.

### DISCLOSURE OF THE INVENTION

An object of the invention is to provide a cleanser having durable easy-cleaning function which allows the decrease of cleaning frequency of a hard article and the reduction of pollution of the environment, and use of the cleanser for cleaning a hard article.

According to an aspect of the invention, there is provided a cleanser comprising an aqueous solvent and 0.05 to 10% by weight of layered silicate dispersed in the aqueous solvent, wherein the layered silicate has an average specific surface area of 100 m²/g or more. The cleanser is in the form of liquid or gel.

According to the invention, a cleanser having durable easy-cleaning function which allows the decrease of cleaning frequency of a hard article and the reduction of pollution of the environment can be provided. The cleanser can reduce labor and expense required for cleaning a hard article due to the decrease of cleaning frequency of a hard article.

In a preferable embodiment of the invention, the cleanser further comprises 0.15 to 32% by weight of a surfactant.

In a preferable embodiment of the invention, the cleanser may have a pH of 6 to 8 without addition of a pH adjustor. According to this embodiment of the invention, a cleanser having both the durable easy-cleaning function and neutral formulation, which allows the decrease of cleaning frequency of a hard article and the reduction of pollution of the environment while causing no corrosion to a hard article and no irritation to a hand of an user due to the use of the neutral formulation, can be provided.

In a preferable embodiment of the invention, the layered silicate preferably has an average specific surface area of 200 m²/g or more, and the content of the layered silicate is preferably 1 to 6% by weight.

In a preferable embodiment of the invention, the surfactant is preferably selected from the group consisting of nonionic surfactant, anionic surfactant, cationic surfactant, zwitterionic surfactant and mixtures thereof. The nonionic surfactant is preferably selected from the group consisting of polyoxyethylene type nonionic surfactants, polyol type nonionic surfactants, alkanolamide type nonionic surfactants, fluorocarbon type nonionic surfactants, organosilicon type and modified organosilicon type nonionic surfactants and mixtures thereof. The anionic surfactant is preferably selected from the group consisting of carboxylate type anionic surfactant, sulfonate type anionic surfactants, sulfate ester salt type anionic surfactants, phosphate ester salt type anionic surfactants and mixtures thereof. The cationic surfactant is preferably selected from the group consisting of heterocycle type cationic surfactants, quaternary ammonium type cationic surfactants and mixtures thereof. The zwitterionic surfactant is preferably selected from the group consisting of amino acid type surfactants, betaine type surfactants and mixtures thereof.

In a preferable embodiment of the invention, the cleanser further comprises a mildew inhibitor, an antibacterial agent, a fragrance, a thickener, a pigment, a dye or a mixture thereof.

In a preferable embodiment of the invention, the layered silicate is selected from the group consisting of bentonite; montmorillonite; kaolin; purified bentonite, purified montmorillonite or purified kaolin; ion modified bentonite, ion modified montmorillonite or ion modified kaolin; and mixtures thereof.

According to another aspect of the invention, there is provided a use of the cleanser as described above for cleaning a hard article. The hard article may be a ceramic article, a stainless steel article, a glass article or a polymer article.

### BEST MODES FOR CARRYING OUT THE INVENTION

The cleanser according to the invention comprises an aqueous solvent and 0.05 to 10% by weight of layered silicate dispersed in the aqueous solvent, wherein the layered silicate has an average specific surface area of 100 m²/g or more. The aqueous solvent used in the invention may be water or a mixture of water and an alcohol or an ether, and preferably water.

In the invention, it is important that the layered silicate has a high specific surface area of 100 m²/g or more. It is believed that the layered silicate having an average specific surface area of 100 m²/g or more contains many surface active sites, whereby the bonding force with the surface to be cleaned is increased so that a hydrophilic protection film remains on a hard article when the hard article is cleaned. Due to the presence of the protection film, the hydrophilicity of the hard article can be kept such that the cleaned surface has durable easy-cleaning function, thereby prolonging the period of cleaning the surface to be cleaned. However, in the case where the specific surface area is lower than 100 m²/g, it is impossible to obtain a stable cleanser system. Preferably, the layered silicate used in the invention has an average specific surface area of 200 m²/g or more. The upper limit of the average specific surface area of the layered silicate is not particularly limited, although the layered silicate preferably has an average specific surface area of 300 m²/g or less.

The specific surface area can be measured by conventional nitrogen adsorption method (BET method). In the invention, when a mixture of the layered silicates is used, a layered silicate in the mixture may have a specific surface area less than 100 m²/g so long as the average specific surface area of the mixture is 100 m²/g or more. The average specific surface area of the mixture can be calculated by the following formula:

S_{average}=Σxᵢ*Sᵢ

S_{average}=an average specific surface area of the mixture of the layered silicates;

xᵢ=weight percent of a layered silicate in the mixture of the layered silicates; and

Sᵢ=a specific surface area of a layered silicate.

In the cleanser according to the invention, the content of the layered silicate is 0.05 to 10% by weight, preferably 1 to 6% by weight, and more preferably 2 to 5% by weight based on the total weight of the cleanser. In the case where the content of the layered silicate is less than 0.05% by weight, the easy-cleaning property of the cleanser is decreased. In the case where the content of the layered silicate is more than 10% by weight, the cleanser has a very high viscosity which results in the inconvenience for user.

In an embodiment of the invention, the cleanser may consist of the layered silicate and an aqueous solvent. In another embodiment of the invention, the cleanser may further comprise a surfactant in addition to the layered silicate and the aqueous solvent. The content of the surfactant is 0.15 to 32% by weight, preferably 0.5 to 10% by weight, and more preferably 1 to 5% by weight based on the total weight of the cleanser.

The surfactant may be selected from the group consisting of nonionic surfactant, anionic surfactant, cationic surfactant, zwitterionic surfactant and mixtures thereof. The nonionic surfactant is preferable.

The nonionic surfactant may be selected from the group consisting of polyoxyethylene type nonionic surfactants such as alkyl phenol polyoxyethylene ethers, high carbon fatty alcohol polyoxyethylene ethers, fatty acid polyoxyethylene esters, polyoxyethylene amines, polyoxyethylene amides, adducts of polypropylene glycol with ethylene oxide, and polyoxyethylenated ionic surfactants; polyol type nonionic surfactants such as sorbitan esters, and saccharose esters; alkanolamide type nonionic surfactants; fluorocarbon type nonionic surfactants; organosilicon type nonionic surfactants; modified organosilicon type nonionic surfactants; and mixtures thereof.

The anionic surfactant may be selected from the group consisting of carboxylate type anionic surfactants; sulfonate type anionic surfactants such as alkyl benzene sulfonates, α-alkene sulfonates, alkyl sulfonates, α-sulfomonocarboxylates, alkyl fatty acid sulfonates, succinate sulfonates, alkyl naphthalene sulfonates, petroleum sulfonates, lignin sulfonates, alkyl glyceryl ether sulfonates and the like; sulfate ester salt type anionic surfactants such as fatty alcohol polyoxyethylene ether sulfate ester salts, sodium dodecyl sulfate and the like; phosphate ester salt type anionic surfactants such as phosphate mono- or di-ester salts of fatty alcohol polyoxyethylene ether and phosphate mono- or di-ester salts of alkyl phenol polyoxyethylene ether; and mixtures thereof.

The cationic surfactant may be selected from the group consisting of heterocycle type cationic surfactants such as biguanides; quaternary ammonium type such as long chain alkyl ammonium bromides and long chain alkyl ammonium chlorides; and mixtures thereof.

The zwitterionic surfactant may be selected from the group consisting of amino acid type surfactants; betaine type surfactants such as coconut oil alkyl dimethyl betaine and coconut oil amide propyl betaine; and mixtures thereof.

The cleanser according to the invention may further comprise an additive. The additive is selected from the group consisting of a mildew inhibitor, an antibacterial agent, a fragrance, a thickener, a pigment, a dye and/or a pH adjustor. The content of the additive is 0.0001 to 2% by weight. The mildew inhibitor or antibacterial agent may be selected from the group consisting of amines, alcohols such as ethanol, aldehydes, isothiazoles such as S-chloro-2-methyl-4-isothiazolin-3-one, imidazoles, esters, chlorine-containing compounds, peroxides, carboxylic acids, anilides, carbamates such as 3-iodo-2-propynyl butylcarbamate, oxides, sulfides, sulfonamides, quaternary ammonium salts, nitriles, biguanide type compounds such as chlorhexidine, pyridines, phenols, phthalimides, iodine-containing compounds and the like. The thickener may be selected from the group consisting of an inorganic thickener such as fumed silica, diatomite, attapulgite clay, silica gel; celluloses such as methyl cellulose, hydroxylpropyl methyl cellulose, sodium carboxymethyl cellulose, hydroxylethyl cellulose, and salts thereof; natural polymers and derivatives thereof such as starch, gelatin, sodium alginate, casein, guar gum, chitosan, arabic gum, xanthan gum, soyabean protein gum, natural rubber, lanolin, and agar; synthetic polymers such as polyacrylamide, polyvinyl alcohol, polyvinylpyrrolidone, polyoxyethylene, polyacrylic acid, poly(sodium acrylate), polyacrylate copolymerized emulsion, and polyurethane. The fragrance may be selected from the group consisting of various synthetic or extracted natural fragrances, such as green apple flavor, lemon flavor, orange flavor and the like. The pigment may be selected from the group consisting of organic pigments and inorganic pigments. The inorganic pigments may be oxides and salts such as sulfides, sulfates, chromates and molybdates of metals, as well as carbon black. The organic pigments may be azo pigments, phthalocyanine pigments, heterocycle pigments, lake pigments, dyes, fluorescent brighteners and fluorescent pigments.

The cleanser of the invention may be produced by dispersing the layered silicate powders in an aqueous solvent. Further, if other components are contained, the other components may be further mixed and dispersed in a dispersion of the layered silicate(s). For example, a certain amount of deionized water is weighted into a vessel, and a certain amount of the layered silicate powders are then slowly added thereto under high speed stirring (for example, using a IKA high speed disperser at a rate of 6500 revolutionsimin) and the resulting mixture is continually stirred and dispersed until the powders are completely dispersed. Thereafter, the dispersed liquid is placed at the room temperature or a certain temperature such as 50° C. for a period of time such that the layered silicate particles are further dispersed into smaller particles so as to increase the transparency. A surfactant and other additives are then added under low speed stirring (for example, at a rate of 100 revolutions/min) and continually stirred for a certain time such that the surfactant and other additives are homogenously dispersed.

The cleanser of the invention may be used for cleaning a hard article such as a ceramic article, a stainless steel article, a glass article and a polymer (for example, PMMA) article and the like. Specifically, the cleanser of the invention is applied to a hard article so as to clean the hard article directly, or the cleanser is applied to a cleaning medium and the hard article is then cleaned with the cleaning medium. The application may be performed by means of spraying, showering and the like.

### EXAMPLES

Hereinafter, the invention are illustrated with reference to the examples, however, these examples do not limit the range of the invention.

The raw materials used in the examples are shown in the Table 1 below.

TABLE 1

| | Name of | | |
|---|---|---|---|
| Type | Product | Chemical Substance | Supplier |
| Layered | KA517 | Bentonite powders with a specific surface | Huate New |
| silicate | | area of 250 m²/g | Materials Co., Ltd, |
| powders | | | Zhejiang |
| | SMP-40 | Sodium ion modified bentonite powders | Fenghong New |
| | | with a specific surface area of 30 m²/g | Materials Co., Ltd, |
| | Montmorillonite | Montmorillonite with a specific surface | Zhejiang |
| | | area of 11 m²/g | |
| | YH-02 | Kaolin with a specific surface area of 14 | Yinhua Kaolin |
| | | m²/g | Industry Co., Ltd, |
| | | | Maoming. |
| | | | Guangdong |
| | HYDRAPRINT | Kaolin with a specific surface area of 15 | KaMin LLC, USA |
| | | m²/g | |
| Nonionic | BEROSOL EC | 20-40 wt % aqueous solution of | AkzoNobel, |
| surfactant | | poly(oxyethylene-co-oxypropylene) | Netherlands |
| | SX-6501A | N,N-bis(hydroxylethyl)coconut amide | Shengxuan |
| | | fatty acid D | Biological-Chemical |
| | | | Co., Ltd., Shanghai |
| Anionic | | Sodium dodecyl sulfate | Sinopharm Group |
| surfactant | | | |
| Zwitterionic | MIRANOL | 50 wt % aqueous solution of disodium | Rhodia, France |
| surfactant | C2M CONC NP | cocoamphodiacetate | |
| Cationic | CHG | chlorhexidine gluconate | DASHENG |
| surfactant | | | CHEMICAL TECH |
| | | | CO., LTD, |
| | | | SHAANXI |
| Antibacterial | KATHON CG | 5-chloro-2-methyl-4-isothiazolin-3-one, | Rohm & Haas |
| agent | | 1.5 wt % | Company, USA |
| Fragrance | Fresh Apple # | | Symrise Shanghai |
| | WT10016 | | Ltd., Shanghai, |
| | | | China |
| Solvent | | anhydrous ethanol | Sinopharm Goup |
| | | propylene glycol methyl ether | |
| Thickener | PAC | polyanionic cellulose | Mingtai Chemical |
| | | | Industry Limited |
| | | | Company, Hebei |

### Example 1

5 g of bentonite KAS 17 with a specific surface area of 250 m/g was added to 95 g of deionized water, dispersed at high speed (13500 revolutions/min) for 15 min, and then placed at the room temperature for at least 2 h so as to obtain a gel having a solid content of 5 wt %. 0.5 g of BEROSOL EC nonionic surfactant was added to the gel and stirred sufficiently and homogenously so as to obtain a colorless and transparent gel having a pH1 range of 7-8.

### Examples 2-8

The cleansers of the Examples 2-8 were produced in the similar manner to the Example 1. The used conditions and results were shown in the Table 2.

### Comparative Examples 1 and 2

The cleansers of the Comparative Examples 1 and 2 were produced in the similar manner to the Example 1. The used conditions and results were shown in the Table 2.

### Example 9

0.25 g of bentonite KA517 with a specific surface area of 250 m²/g and 0.25 g modified bentonite with a specific surface area of 30 m²/g were added to 49.5 g of deionized water, dispersed at high speed (13500 revolutions/min) for 15 min, and then placed at the room temperature for at least 2 h so as to obtain a gel having a solid content of 1 wt %. 0.09 g of BEROSOL EC nonionic surfactant was added to the gel and stirred sufficiently and homogenously so as to obtain an opaque liquid having a pH range of 6-7.

### Examples 10-12

The cleansers of the Examples 10-12 were produced in the similar manner to the Example 9. The used conditions and results were shown in the Table 2.

### Comparative Examples 3 and 4

The cleansers of the Comparative Examples 3 and 4 were produced in the similar manner to the Example 9. The used conditions and results were shown in the Table 2.

### Example 13

3.3 g of bentonite KA517 with a specific surface area of 250 m₂/g was added to 96.7 g of deionized water, dispersed at high speed (13500 revolutions/min) for 10 min, and then placed at the room temperature for at least 2 h so as to obtain a gel having a solid content of 3.3 wt %. 0.5 g of BEROSOL EC nonionic surfactant was added to the gel and stirred sufficiently and homogenously, and 5 g of anhydrous ethanol was then added so as to obtain a transparent gel having a pH range of 7-8.

### Examples 14-16

The cleansers of the Examples 14-16 were produced in the similar manner to the Example 13. The used conditions and results were shown in the Table 2.

### Example 17

0.05 g of bentonite KA517 with a specific surface area of 250 m²/g was added to 99.95 g of deionized water, dispersed at high speed (13500 revolutions/min) for 10 min, and then placed at the room temperature for at least 2 h so as to obtain a transparent liquid having a solid content of 0.05 wt % and a pH range of 7-8.

### Example 18

The cleanser of the Example 18 was produced in the similar manner to the Example 17. The used conditions and results were shown in the Table 2.

### Comparative Example 5

The cleanser of the Comparative Example 5 was produced in the similar manner to the Example 17. The used conditions and results were shown in the Table 2.

### Example 19

1.5 g of bentonite KA517 with a specific surface area of 250 m₂/g was added to 98.5 g of deionized water, dispersed at high speed (13500 revolutions/min) for 10 min. and then placed at the room temperature for at least 2 h so as to obtain a transparent liquid having a solid content of 1.5 wt % and a pH range of 7-8.5 wt % aqueous NaOH solution was added dropwise so as to adjust pH to be 10-11.

### Comparative Example 6

The cleanser of the Comparative Example 6 was produced in the similar manner to the Example 19. The used conditions and results were shown in the Table 2.

The surface hydrophilicity, surface hydrophilicity durability and oil removal performance of the cleansers of the invention produced in the examples were evaluated according to the following measuring methods.

### 1. Surface Hydrophilicity Test

1 g of each cleanser produced in the examples was applied to a surface of a hard article (for example, ceramic tile). The hard article was brushed back and forward with a 3M SCOTCH-BRITE toilet brush for 10 times. The residual cleanser was then removed by water rinsing and the hard article was naturally dried. The initial contact angle of the above surface with water was measured using Kruss DSA100 contact angle tester. The smaller the contact angle was, the better the hydrophilicity.

### 2. Surface Hydrophilicity Durability Test

The test sample was put on a 45° tilted stainless steel panel and a water tank was fixed above the sample at a level of 2 meters. A stainless steel water pipe with 1.7 meter length and 1 cm diameter was vertically placed below the water tank. A relay is set to control the water rinsing rate. Each time rinsing duration was 7 s, and the water volume was 800 ml. After water rinsing for 50 times, the surface was dried by blowing with a stream of compressed air for 90 seconds, and then the contact angles were tested and recorded.

### 3. Oil Removal Performance Test

1 drop of vegetable oil mixed with carbon black was dropped on the tested panel and then wiped off with paper or cloth under water stream. The presence or absence of the oil stain was visually observed. It was generally observed whether a water film was still present in the measured area. If there was a water film in the measured area, then the measured surface was blown with a stream of compressed air for 90 seconds, and the above step was repeated until the oil cannot be thoroughly removed and the test number was recorded. If the test was passed for 20 times, then the test was stopped and the test number “>20” was recorded.

The results of the surface hydrophilicity, surface hydrophilicity durability and oil removal performance of the cleansers of the invention were shown in the Table 2.

TABLE 2

| | | | | | | | | Properties of the Product | | | | | | |
|---|---|---|---|---|---|---|---|---|---|---|---|---|---|---|
| | Layered Silicate | | | | | | | | | | | | | Contact Angle |
| | | Average specific | | Surfactant | | Other Additive | | | | | | | Initial | after the |
| | | surface area | Content | | Content | | Content | | | | Hard | Oil Removal | Contact | Durability |
| No. | Type | (m²/g)^{a} | (wt %) | Type | (wt %) | Type | (wt %) | pH | Appearance | Stability^{b} | Article | Performance | Angle (°) | Test (°) |
| Ex. 1 | Bentonite | 250 | 4.97 | BEROSOL EC | 0.50 | | | 7-8 | Transparent | Stable | Ceramic | >20 | 10 | 10.6 |
| | | | | nonionic | | | | | gel | | | | | |
| | | | | surfactant | | | | | | | | | | |
| Ex. 2 | Bentonite | 250 | 9.95 | BEROSOL EC | 0.50 | | | 7-8 | Transparent | Stable | Ceramic | >20 | 9.4 | 22.0 |
| | | | | nonionic | | | | | gel | | | | | |
| | | | | surfactant | | | | | | | | | | |
| Ex. 3 | Bentonite | 250 | 2.45 | BEROSOL EC | 30.07 | | | 7-8 | Transparent | Stable | Ceramic | 2 | 10 | 9.1 |
| | | | | nonionic | | | | | liquid | | | | | |
| | | | | surfactant | | | | | | | | | | |
| Ex. 4 | Bentonite | 250 | 1.00 | Sodium dodecyl | 1.00 | | | 6-7 | Transparent | Stable | Ceramic | >20 | 3.6 | 7.6 |
| | | | | sulfate anionic | | | | | gel | | | | | |
| | | | | surfactant | | | | | | | | | | |
| Ex. 5 | Bentonite | 250 | 3.48 | Cationic | 0.50 | | | 7-8 | Transparent | Stable | Ceramic | 12 | 9.7 | 14.3 |
| | | | | surfactant CHG | | | | | gel | | | | | |
| Ex. 6 | Bentonite | 250 | 2.00 | MIRANOL | 0.50 | | | 7-8 | Transparent | Stable | Ceramic | >20 | 7.0 | 18.5 |
| | | | | C2M CONC NP | | | | | and | | | | | |
| | | | | zwitterionic | | | | | thick | | | | | |
| | | | | surfactant | | | | | liquid | | | | | |
| Ex. 7 | Bentonite | 250 | 2.80 | BEROSOL EC | 20.00 | | | 7-8 | Transparent | Stable | Ceramic | 12 | 4.8 | 15.8 |
| | | | | nonionic | | | | | gel | | | | | |
| | | | | surfactant | | | | | | | | | | |
| | | | | | | | | | | | Glass | | 5.5 | 6.8 |
| | | | | | | | | | | | Stainless steel | | 7.4 | 14.0 |
| Ex. 8 | Bentonite | 250 | 3.14 | BEROSOL EC | 10.39 | | | 7-8 | Transparent | Stable | Ceramic | 14 | 4.8 | 15.8 |
| | | | | nonionic | | | | | gel | | | | | |
| | | | | surfactant | | | | | | | | | | |
| Ex. 9 | Bentonite/ | 140 | 1.00 | BEROSOL EC | 0.17 | | | 6-7 | Opaque | Stable | Ceramic | >20 | 12.8 | 20.7 |
| | modified | | | nonionic | | | | | liquid | | | | | |
| | bentonite | | | surfactant | | | | | | | | | | |
| | (1:1 = :w:w) | | | | | | | | | | | | | |
| Ex. 10 | Bentonite/ | 109 | 1.00 | BEROSOL EC | 0.33 | | | 6-7 | Opaque | Stable | Ceramic | >20 | 12.7 | 14.7 |
| | modified | | | nonionic | | | | | liquid | | | | | |
| | bentonite | | | surfactant | | | | | | | | | | |
| | (1:1.8 = :w:w) | | | | | | | | | | | | | |
| Ex. 11 | Bentonite/ | 170 | 1.00 | BEROSOL EC | 0.50 | | | 6-7 | Opaque | Stable | Ceramic | >20 | 10.6 | 9.9 |
| | montmorillonite | | | nonionic | | | | | liquid | | | | | |
| | (1:0.5 = :w:w) | | | surfactant | | | | | | | | | | |
| Ex. 12 | Bentonite/ | 171 | 1.00 | BEROSOL EC | 0.24 | | | 6-7 | Opaque | Stable | Ceramic | >20 | 12.5 | 15.5 |
| | kaolin | | | nonionic | | | | | liquid | | | | | |
| | (YH-02) | | | surfactant | | | | | | | | | | |
| | (1:0.5 = :w:w) | | | | | | | | | | | | | |
| Ex. 13 | Bentonite | 250 | 3.13 | BEROSOL EC | 0.47 | Ethanol | 4.74 | 7-8 | Transparent | Stable | Ceramic | 4 | 13.3 | 13.3 |
| | | | | nonionic | | | | | gel | | | | | |
| | | | | surfactant | | | | | | | | | | |
| Ex. 14 | Bentonite | 250 | 2.99 | BEROSOL EC | 0.45 | Propylene | 9.05 | 7-8 | Transparent | Stable | Ceramic | 6 | 7.8 | 18.8 |
| | | | | nonionic | | glycol | | | and | | | | | |
| | | | | surfactant | | methyl | | | thick | | | | | |
| | | | | | | ether | | | liquid | | | | | |
| Ex. 15 | Bentonite | 250 | 2.77 | BEROSOL EC | 0.40 | PAC | 0.20 | 7-8 | Transparent | Stable | Ceramic | 9 | 9.8 | 14.8 |
| | | | | nonionic | | thickener | | | gel | | | | | |
| | | | | surfactant | | Poly- | | | | | | | | |
| | | | | | | anionic | | | | | | | | |
| | | | | | | cellulose | | | | | | | | |
| Ex. 16 | Bentonite | 250 | 4.75 | Nonionic | 5.00 | KATHON | 0.30 | 7-8 | Semi- | Stable | Ceramic | >20 | 6.4 | 7.9 |
| | | | | surfactant | | CG | 0.03 | | transparent | | | | | |
| | | | | SX-6501A | | anti- | | | gel | | | | | |
| | | | | | | bacterial | | | | | | | | |
| | | | | | | agent & | | | | | | | | |
| | | | | | | WT10016 | | | | | | | | |
| | | | | | | fragrance | | | | | | | | |
| Ex. 17 | Bentonite | 250 | 0.05 | | | | | 7-8 | Transparent | Stable | Ceramic | 10 | 12.0 | 17.6 |
| | | | | | | | | | liquid | | | | | |
| Ex. 18 | Bentonite | 250 | 10.00 | | | | | 7-8 | Transparent | Stable | Ceramic | >20 | 14.2 | 13.2 |
| | | | | | | | | | gel | | | | | |
| Ex. 19 | Bentonite | 250 | 1.50 | | | pH | | 10-11 | Transparent | Stable | Ceramic | >20 | 7.9 | 12.7 |
| | | | | | | adjustor | | | liquid | | | | | |
| | | | | | | NaOH | | | | | | | | |
| Comp. Ex. 1 | Modified | 30 | 1.50 | BEROSOL EC | 0.50 | | | 7-8 | Opaque | Unstable | —^{c} | —^{c} | —^{c} | —^{c} |
| | bentonite | | | nonionic | | | | | liquid | | | | | |
| | | | | surfactant | | | | | | | | | | |
| Comp. Ex. 2 | Kaolin | 15 | 3.00 | BEROSOL EC | 0.50 | | | 7-8 | Opaque | Unstable | —^{c} | —^{c} | —^{c} | —^{c} |
| | (HYDRAPRINT) | | | nonionic | | | | | liquid | | | | | |
| | | | | surfactant | | | | | | | | | | |
| Comp. Ex. 3 | Bentonite/ | 84 | 2.00 | BEROSOL EC | 0.50 | | | 7-8 | Opaque | Unstable | —^{c} | —^{c} | —^{c} | —^{c} |
| | montmorillonite | | | nonionic | | | | | liquid | | | | | |
| | (1:2 = | | | surfactant | | | | | | | | | | |
| | :w:w) | | | | | | | | | | | | | |
| Comp. Ex. 4 | Bentonite/ | 57 | 5.00 | BEROSOL EC | 0.50 | | | 6-7 | White | Unstable | —^{c} | —^{c} | —^{c} | —^{c} |
| | kaolin | | | nonionic | | | | | liquid | | | | | |
| | (1:4 = :w:w) | | | surfactant | | | | | | | | | | |
| Comp. Ex. 5 | Montmorillonite | 16 | 5.00 | | | | | 6-7 | Yellowish | Unstable | —^{c} | —^{c} | —^{c} | —^{c} |
| | | | | | | | | | Opaque | | | | | |
| | | | | | | | | | liquid | | | | | |
| Comp. Ex. 6 | Modified | 30 | 1.50 | | | pH | | 10-11 | Opaque | Unstable | —^{c} | —^{c} | —^{c} | —^{c} |
| | bentonite | | | | | adjustor | | | liquid | | | | | |
| | | | | | | NaOH | | | | | | | | |

^{a}It was measured by ASAP2010 (Micromeritics, U.S.A) instrument. The measured procedure was as follows: the sample tube was heated at 160 C. and degassed under vacuum for at least 2 h until the vacuum reached 2 μmHg. After the sample was charged, the sample tube was heated at 100 C. and degassed under vacuum for at least 8 h until the vacuum reached 2 μmHg.
^{b}Method for evaluating the stability: a gel was charged into a glass bottle and sealed, and placed at RT for 10 days. Then, it was observed whether there was water bleeding from the gel. If there was water bleeding, the gel was marked as “unstable”; if there was not water bleeding, the gel was marked as “stable”.
^{c}“—” in the comparative examples 1-6 represents that the system is unstable such that the data were not available.

As shown in the above Table 2, the initial contact angles of the cleansers of the invention were within 15°, indicating that the cleansers have excellent hydrophilicity. After water rinsing for 50 times, the contact angles of the cleansers of the invention remain within 22°, indicating that the cleansers have excellent surface hydrophilicity durability. In addition, the cleansers of the invention further have good oil removal performance. However, in the comparative examples 1-6, it is impossible to obtain a stable cleanser system due to the specific surface area less than 100 m²/g.

The embodiments of the present invention are summarized as follows:

Item 1 is a cleanser comprising an aqueous solvent and 0.05 to 10% by weight of layered silicate dispersed in the aqueous solvent, wherein the layered silicate has an average specific surface area of 100 m²/g or more.

Item 2 is the cleanser of item 1 further comprising 0.15 to 32% by weight of a surfactant.

Item 3 is the cleanser of item 1 or item 2 having a pH of 6 to 8.

Item 4 is the cleanser of item 1 or item 2, wherein the layered silicate has an average specific surface area of 200 m²/g or more.

Item 5 is the cleanser of item 1 or item 2, wherein the content of the layered silicate is 1 to 6% by weight.

Item 6 is the cleanser of item 2, wherein the surfactant is selected from the group consisting of a nonionic surfactant, an anionic surfactant, a cationic surfactant, a zwitterionic surfactant and mixtures thereof.

Item 7 is the cleanser of item 6, wherein the nonionic surfactant is selected from the group consisting of polyoxyethylene type nonionic surfactants, polyol type nonionic surfactants, alkanolamide type nonionic surfactants, fluorocarbon type nonionic surfactants, organosilicon type nonionic surfactants, modified organosilicon type nonionic surfactants and mixtures thereof.

Item 8 is the cleanser of item 6, wherein the anionic surfactant is selected from the group consisting of carboxylate type anionic surfactants, sulfonate type anionic surfactants, sulfate ester salt type anionic surfactants, phosphate ester salt type anionic surfactants and mixtures thereof.

Item 9 is the cleanser of item 6, wherein the cationic surfactant is selected from the group consisting of heterocycle type cationic surfactants, quaternary ammonium type cationic surfactants and mixtures thereof.

Item 10 is the cleanser of item 6, wherein the zwitterionic surfactant is selected from the group consisting of amino acid type surfactants, betaine type surfactants and mixtures thereof.

Item 11 is the cleanser of item 1 or item 2 further comprising a mildew inhibitor, an antibacterial agent, a fragrance, a thickener, a pigment, a dye or a mixture thereof.

Item 12 is the cleanser of item 1 or item 2, wherein the layered silicate is selected from the group consisting of bentonite; montmorillonite; kaolin; purified bentonite, purified mnontmorillonite or purified kaolin; ion modified bentonite, ion modified montmorillonite or ion modified kaolin; and mixtures thereof.

Item 13 is the cleanser of item 1 or item 2, wherein the cleanser is in the form of liquid or gel.

Use of the cleanser of any one of items 1 to 13 for cleaning a hard article. The hard article is a ceramic article, a stainless steel article, a glass article or a polymer article.

1. A cleanser comprising an aqueous solvent and 0.05 to 10% by weight of layered silicate dispersed in the aqueous solvent, wherein the layered silicate has an average specific surface area of 100 m²/g or more.

2. The cleanser according to claim 1 further comprising 0.15 to 32% by weight of a surfactant.

3. The cleanser according to claim 1 having a pH of 6 to 8.

4. The cleanser according to claim 1, wherein the layered silicate has an average specific surface area of 200 m²/g or more.

5. The cleanser according to claim 1, wherein the content of the layered silicate is 1 to 6% by weight.

6. The cleanser according to claim 2, wherein the surfactant is selected from the group consisting of a nonionic surfactant, an anionic surfactant, a cationic surfactant, a zwitterionic surfactant and mixtures thereof.

7. The cleanser according to claim 6, wherein the nonionic surfactant is selected from the group consisting of polyoxyethylene type nonionic surfactants, polyol type nonionic surfactants, alkanolamide type nonionic surfactants, fluorocarbon type nonionic surfactants, organosilicon type nonionic surfactants, modified organosilicon type nonionic surfactants and mixtures thereof.

8. The cleanser according to claim 6, wherein the anionic surfactant is selected from the group consisting of carboxylate type anionic surfactants, sulfonate type anionic surfactants, sulfate ester salt type anionic surfactants, phosphate ester salt type anionic surfactants and mixtures thereof.

9. The cleanser according to claim 6, wherein the cationic surfactant is selected from the group consisting of heterocycle type cationic surfactants, quaternary ammonium type cationic surfactants and mixtures thereof.

10. The cleanser according to claim 6, wherein the zwitterionic surfactant is selected from the group consisting of amino acid type surfactants, betaine type surfactants and mixtures thereof.

11. The cleanser according to claim 1 further comprising a mildew inhibitor, an antibacterial agent, a fragrance, a thickener, a pigment, a dye or a mixture thereof.

12. The cleanser according to claim 1, wherein the layered silicate is selected from the group consisting of bentonite; montmorillonite; kaolin; purified bentonite, purified montmorillonite or purified kaolin; ion modified bentonite, ion modified montmorillonite or ion modified kaolin; and mixtures thereof.

13. The cleanser according to claim 1, wherein the cleanser is in the form of liquid or gel.

14. A method of cleaning a hard article comprising applying the cleanser of claim 1 to the article.

15. The according to claim 14, wherein the hard article is a ceramic article, a stainless steel article, a glass article or a polymer article.
